(19) United States
(12) Patent Application Publication
(10) Pub. No.: US 2002/0189513 A1
(43) Pub. Date: Dec. 19, 2002

(54) Furrow opener for dual shank seeders

(76) Inventor: Norbert Beaujot, Saskatchewan (CA)

Correspondence Address: NIXON & VANDERHYE P.C., 8th Floor, 1100 North Glebe Road, Arlington, VA, 22201-4714, US

(21) Appl. No.: 10/152,984

(22) Filed: May 23, 2002

(30) Foreign Application Priority Data
May 25, 2001 (CA) 2,348,738

(51) Int. Cl. A01C 7/00

(52) U.S. Cl. 111/186

(57) ABSTRACT

A seeder comprises a front furrow opener forming a first furrow and a rear furrow opener forming a second furrow beside the first furrow. The rear furrow opener has a ground engaging front face oriented at an angle to the operating travel direction such that a far side of the face, farthest from the first furrow, is ahead of an opposite near side of the face such that soil engaged by the face is pushed toward the first furrow, and the rear furrow opener tends to move away from the first furrow. A membrane between the paired shanks of the furrow openers facilitates trash flow and reduces trash build up on the rear shank.

This invention is in the field of agricultural seeders and in particular such seeders for simultaneously depositing seed and fertilizer in separate bands.

### BACKGROUND

No-till seeders for seeding directly into standing stubble and residue from a prior crop without cultivation are well known in modern grain farming. Some types of seeders, known as double-shoot seeders, place separate bands of seed and fertilizer in the soil simultaneously. Such separation of the bands is necessary with higher fertilizer rates to prevent damage to the seed.

As with all seeders, seed should be placed at a consistent depth on a bed of undisturbed soil. The fertilizer should be placed at a consistent depth preferably deeper than the seed and laterally offset from the seed sufficient to prevent seed damage, but close enough to provide nutrients early in plant growth. In typical seeders, the fertilizer is placed first in a fertilizer furrow, and some soil is allowed to fall back onto the fertilizer before the seed is placed in order to ensure separation. In order to provide the undisturbed soil for the seed bed, a second seed furrow is preferably created above and to one or both sides of the fertilizer.

Various types of double-shoot seeders have been developed. In some, the fertilizer and seed furrow openers are fastened together, as illustrated in U.S. Pat. No. 4,607,581 to Kopecky. The Stealth™ opener of Flexi-coil Ltd. of Saskatoon, Canada is another example of this integrated dual furrow opener, which creates separate fertilizer and seed furrows, and channels seed and fertilizer to the respective furrows to create separated bands.

The dual furrow opener is connected to the bottom end of a leg or shank extending down from the implement frame. The shank can be hollow and define channels for seed and fertilizer, as illustrated in the device of Kopecky, or the shank can be solid, with seed and fertilizer delivered to the furrow opener by tubes.

In other double-shoot seeders, the fertilizer and seed furrow openers are separated by some distance. A front fertilizer furrow opener creates a fertilizer furrow. A rear seed furrow opener is positioned some distance behind and to one side of the fertilizer furrow opener and creates a seed furrow at a shallower depth than the fertilizer furrow, and at a small distance to one side of the fertilizer furrow. Such seeders with separated seed and fertilizer furrow openers, are disclosed in Canadian Patent Number 1,239,835 to Halford, in U.S. Pat. Nos. 5,331,907 and 5,396,851 to the present inventor Beaujot, and in U.S. Pat. No. 5,609,114 to Barton.

In the Halford and Beaujot devices, the furrow openers are stationary blade-type openers which cut through the soil to form the furrow. These blade-type openers are also commonly referred to as knife openers when they are narrow, or hoe openers when they are wider. Blade-type openers are characterized by their fixed nature, with no moving parts. In the device of Barton, on the other hand, the furrow openers are disk-type openers, comprising disks which rotate as they cut through the soil. Regardless of the type of opener, in the Halford, Beaujot, and Barton devices it is clear that there is a substantial separation between the front and rear furrow openers, in contradistinction to the integrated furrow openers of Kopecky and Flexi-coil's Stealth™.

In the Halford and Beajot devices, the front fertilizer furrow opener is mounted on a front shank, while the rear seed furrow opener is mounted separately and behind the front fertilizer furrow opener on a rear shank extending downward, thus providing separation between the openers. Commonly, the bottom of the shank actually forms the furrow, thus not requiring any separate furrow opener attached thereto. Each shank forms only one furrow, and so this simple furrow opener is economical and practical.

In the Barton device, the front fertilizer furrow opening disk is mounted on a shank extending down from the frame. The rear seed furrow opening disk is mounted separately and behind the front fertilizer furrow opening disk. The separation of the furrow opening disks is provided by an arm attached to the shank near the bottom end of the shank and extending rearward to where the rear seed furrow opening disk is attached.

To ensure the desirable firm seed bed, the orientation of the seed and fertilizer furrow openers should be maintained such that the rear seed furrow opener operates in soil beside the front fertilizer furrow that has not been disturbed by the preceding front fertilizer furrow opener. On seeders with separated front fertilizer and rear seed furrow openers, this can be problematic.

The rear seed opener is creating a seed furrow that is very close to an open fertilizer furrow, such that only an inch or so of soil separates them. Especially where the soil is hard, the rear furrow opener tends to move toward the existing adjacent fertilizer furrow since there is little lateral force exerted from that direction, while in the opposite direction the soil is undisturbed and so resists. The soil in the lateral separation area is also somewhat fractured by the action of the front fertilizer furrow opener as it passes.

The result of this tendency is negligible in the integrated dual furrow openers, because the relative positions of the furrow forming elements are fixed, rigid, and close together. Where the front fertilizer and rear seed furrow openers are separated however, the result can be that the seed furrow opener moves too close to the fertilizer furrow, or in fact moves on top of it. The relatively lengthy arm or shank holding the rear seed furrow opener in position is subject to leverage forces transmitted from the furrow opener to the mounting of the arm or shank which can cause bending. The result is especially noticeable where linkages and mounts become worn.

Also, because of the front to rear separation between the fertilizer and seed furrow openers, inevitably during turns or while following curves in the field, the rear seed furrow opener will sometimes follow directly in the fertilizer furrow created by the front fertilizer furrow opener. As the seeder straightens out, the seed furrow opener must then break through the wall of the fertilizer furrow to assume its proper position in undisturbed soil beside the fertilizer furrow. Where the soil is hard, the seed shank can bend slightly such that the seed furrow opener follows in the fertilizer furrow for some considerable distance before breaking through the fertilizer furrow wall and moving to the proper position. It must be remembered that the desired lateral separation between the furrows is on the order of 1.0 to 1.5 inches. Small deflections of the arm or shank holding the rear seed furrow opener can be significant.

To ensure separation of fertilizer and seed, it is desirable to have some soil fall into the fertilizer furrow before the seed is placed. As well, the soil disturbed by the seed furrow opener should be packed firmly over the seed to facilitate fast germination and reduce evaporation in the vicinity of the seed. A problem with these seeders is that the ground engaging front face of a conventional furrow opener is symmetrical so that soil is thrown more or less equally and randomly to both sides of the furrow opener. It is important to maintain sufficient loose soil close to the furrows, and to have the soil move to locations desirable for proper filling of the seed and fertilizer furrows.

On seeders with separated front and rear furrow openers, there are inherent problems with the flow of soil and residue around the rear opener. Compared to integrated furrow openers, the soil and residue must flow around twice as many shanks so there is an increased tendency for residue wadding and plugging around the openers. The shanks are closer together, restricting the space available for residue flow, and residue tends to wrap around the front fertilizer shank and land and collect on the seed shank behind it. If wads of residue collect and drag, then drop off the seed shank, or collect and plug around the seed shank, proper operation of the seeder is inhibited, and the operator may have to stop and clear residue from the seeder.

Canadian Patent Number 1,239,835 to Halford discloses a pair of deflector plates attached to the front fertilizer shank and extending rearwards on each side of the seed shank to just in front of the packer wheel. These deflector plates deflect trash away from the shanks and packer wheel, and prevent trash from collecting. The bottom edge of the plates coincides generally with the ground. Wet soil however can quickly build up on these plates, and actually exacerbate the residue flow problem.

### SUMMARY OF THE INVENTION

It is an object of the present invention to provide a double-shoot seeder with separated front and rear furrow openers making first and second laterally separated furrows wherein the separation of the first and second furrows is more consistent.

It is a further object of the present invention to provide a rear furrow opener having a front face oriented at an angle to an operating travel direction such that soil engaged by the face is pushed toward the first furrow made by the front furrow opener, and such that the rear furrow opener tends to move away from the first furrow.

It is a further object of the present invention to provide a double-shoot seeder with separate front and rear furrow openers wherein the inherent problems of soil and residue flow around the rear opener are reduced.

In a first aspect the invention provides a seeder for depositing first and second agricultural products in laterally separated furrows in the ground when traveling along the ground in an operating travel direction. The seeder comprises a front furrow opener mounted on the seeder so as to engage the ground and form a first furrow therein and a first tube for delivering the first agricultural product to the first furrow. A rear furrow opener is mounted on the seeder separately and behind the front furrow opener so as to engage the ground and form a second furrow therein beside the first furrow. The rear furrow opener has a ground engaging front face oriented at an angle to the operating travel direction such that a far side of the face, farthest from the first furrow, is ahead of an opposite near side of the face such that soil engaged by the face is pushed toward the first furrow. A second tube delivers the second agricultural product to the second furrow.

In a second aspect the invention provides a shank assembly adapted for mounting on a seeder frame to deposit fertilizer and seed in laterally separated bands in the ground. The shank assembly comprises a front shank having a bottom end adapted to engage the ground and form a first furrow therein and a fertilizer tube for delivering fertilizer to the first furrow. A rear shank is located behind the front shank and has a bottom end adapted to engage the ground and form a second furrow therein beside the first furrow. A seed tube delivers seed to the second furrow. The bottom end of the rear shank has a substantially flat ground engaging front face oriented at an angle to the operating travel direction such that a far side of the face, farthest from the first furrow, is ahead of an opposite near side of the face such that soil engaged by the face is pushed toward the first furrow.

The angle of the front face of the rear furrow opener at the bottom of the rear shank guides the soil being moved by the opener toward the front furrow where the agricultural material deposited is typically fertilizer. This improves the filling of the fertilizer furrow and reduces the risk of seed, as the second agricultural material, falling too close to the potentially harmful fertilizer. Of course some of the soil dislodged by the front furrow opener will still move away from the first furrow, but substantially more of the disturbed soil will be moved towards the first furrow than is the case with conventional symmetrical furrow openers. The soil that does move away from the first furrow will not move as far, leaving more soil in the general area of the first and second furrows so that better filling of both furrows can be expected.

The angled front face of the rear furrow opener performs a second important function as it tends to hold the rear furrow opener in its proper position beside the first furrow in soil that is undisturbed by the front furrow opener. As the furrow opener cuts through the soil, the angled front face pushes it away from the first furrow, as the angled face bites into the soil on the side opposite the first furrow. On turns and curves where the rear shank travels in the first furrow, the opener will penetrate the wall better, both because of the sharper edge, and because soil contacting the front face will exert a force away from the first furrow. The rear furrow opener will more quickly assume its proper position, and will be subjected to reduced bending forces that result from failure to penetrate the furrow wall. Where shank linkages and mounts are loose and worn, the furrow opener will tend to pull away from the first furrow rather than toward it. The angled face compensates for and works against the natural tendency of the rear shank to move towards the first furrow because of the reduced resistance of the narrow wall of soil in that direction.

A further benefit to the angled front face is it provides the opportunity for thickening the abrasive resistant material on the leading side of the opener where the greatest wear takes place. The opener leading side furthest from the fertilizer furrow generally experiences higher wear due to the higher forces developed in moving soil a greater distance to a loosened area.

In a third aspect the invention provides a seeder for depositing first and second agricultural products in laterally separated furrows in the ground when traveling along the ground in an operating travel direction. The seeder comprises a front shank mounted on the seeder and having a bottom end adapted to engage the ground and form a first furrow therein and a first tube for delivering the first agricultural product to the first furrow. A rear shank mounted on the seeder behind the front shank has a bottom end adapted to engage the ground and form a second furrow therein beside the first furrow, and a second tube delivers the second agricultural product to the second furrow. A flexible membrane is attached between the front and rear shanks, the membrane having a bottom edge in proximity to the ground when in an operating position, and the membrane extending upward from the bottom edge.

The flexible membrane prevents residue from twisting around the front shank and collecting on the rear shank. This membrane is flexible to maintain the independent movement of the two shanks. Independent movement may be necessary in their normal operation, or while tripping of one or both shanks, or for moving in and out of the transport position. The flexible nature of the membrane reduces the incidence of mud or residue sticking to the joining member in wet conditions compared to a rigid plate. As the membrane flexes, mud and residue will fall off.

The membrane could be elastic, fabricated from a rubberized belting canvas type material with a reinforcing element incorporated into the bottom, higher wearing, ground contacting edge. A chain or cable made from metal or high wear plastic could be utilized as the reinforcing element. The membrane could be perforated, made for instance from interconnected links, or fabricated from a series of chains that are interconnected or independent of each other within the span between the shanks. While such a membrane could provide some improvement in trash flow, it is contemplated that a non-perforated membrane would be preferred, as straw would not then collect in the openings of a perforated membrane.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a side view of a seeder with a shank assembly of the invention mounted thereon;

FIG. 2 is a cross-sectional top view of the shanks of FIG. 1;

FIG. 3 is a schematic cross-sectional top view of the rear shank;

FIG. 4 is a side view of an alternate shank;

FIG. 5 is a cross-sectional top view of the shank of FIG. 4;

FIG. 6 is a side view of a membrane joining the front and rear shanks;

FIG. 7 is a cross-sectional end view of the bottom edge of the membrane of FIG. 6;

FIG. 8 is a side view of an alternate shank assembly of the invention.

### DETAILED DESCRIPTION OF THE ILLUSTRATED EMBODIMENTS

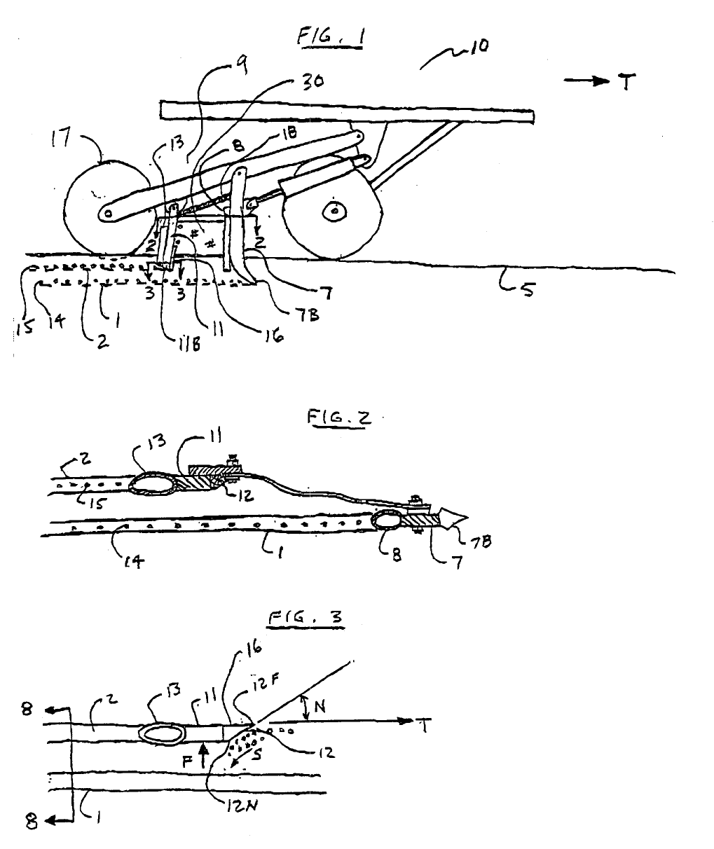

FIG. 1 illustrates a seeder 10 for depositing first and second agricultural products in laterally separated furrows 1, 2 in the ground 5 when traveling along the ground 5 in an operating travel direction T.

The seeder 10 includes the desired number of shank assemblies 9 mounted thereto. The shank assembly 9 is illustrated in FIG. 1 and comprises a front shank 7 having a bottom end 7B forming a front furrow opener adapted to engage the ground 5 and form a first furrow 1 therein. A first tube 8 is attached to the rear side of the front shank 7 and delivers the first agricultural product to the first furrow 1. A rear shank 11 is mounted on the shank assembly 9 behind the front shank 7 and has a bottom end 11B forming a rear furrow opener adapted to engage the ground 5 and form a second furrow 2 therein beside the first furrow 1, as illustrated in FIG. 2. A second tube 13 delivers the second agricultural product to the second furrow 2.

The bottom end 11B of the rear shank 11 has a substantially flat ground engaging front face 12 oriented at an angle N to the operating travel direction T such that a far side 12F of the face 12, farthest from the first furrow 1, is ahead of an opposite near side 12N of the face 12. As the bottom end 11B of the rear shank 11 moves through the ground 5, soil engaged by the face 12 is pushed toward the first furrow 1, as illustrated by arrow S in FIG. 3, and at the same time resistance of the ground 5 creates a force on the shank 11 in direction F which tends to push the rear shank 11 away from the first furrow 1.

Typically, the first agricultural product will be fertilizer 14, deposited in the first furrow 1 formed by the front shank 7, and typically as well, this first furrow 1 will be somewhat deeper than the second furrow 2. Seed 15 is typically deposited in the second shallower furrow 2. The fertilizer 14 and seed 15 are thus placed in the desired laterally separated bands in the ground 5.

Thus the angle N of the front face 12 of the rear shank 11 guides the soil being moved by the shank 11 toward the first furrow 1 where fertilizer 14 is deposited. This improves the filling of the fertilizer furrow 1 and reduces the risk of seed 15 falling too close to the potentially harmful fertilizer 14. There is also less soil thrown away from the general area of the first and second furrows 1, 2 so that better filling of both furrows 1, 2 can be expected.

The angled front face 12 also holds the rear shank 11 in its proper position beside the first furrow 1 in soil that is undisturbed by the front shank 7. As the rear shank 11 cuts through the soil, the angled front face 12 pushes it away from the first furrow 1. The angled face 12 compensates for and works against the natural tendency of the rear shank 11 to move towards the first furrow 1 that results from the reduced resistance of the narrow portion of undisturbed ground between the two.

The angled front face 12 provides the opportunity for thickening an abrasive resistant material on the leading side 12F of the rear shank 11 where the greatest wear takes place due to the higher forces developed in moving soil a greater distance to a loosened area. As illustrated in FIGS. 1-3, the front face 12 is provided by a hardened member 16 attached to the front of the rear shank 11. The hardened member 16 is much thicker, in direction T, at the far side of the face 12F than at the near side 12N.

The angle N between the front face 12 of the rear shank 11 and the operating travel direction T is contemplated for most conditions to be less than 70 degrees, and generally between 30 and 70 degrees.

The bottom ends 7B, 11B of the front and rear shanks 7, 11 are the front and rear furrow openers. Alternatively, a separate arrow opening attachment 21 can be supplied. FIGS. 4 and 5 illustrate a conventional hollow shank 20 wherein the tube for delivering agricultural material is incorporated in the shank 20. The furrow opening attachment 21 is attached with a clamp 22 or the like to the bottom end thereof as is known in the art. The front face 12 of the furrow opening attachment 21 is oriented at an angle as in the other embodiments, and in addition is sloped back from the bottom end for improved penetration. The angled front face 12 performs the same functions as described above. The angled front face can be adapted to conventional furrow openers of many types where the characteristics thereof would provide a benefit.

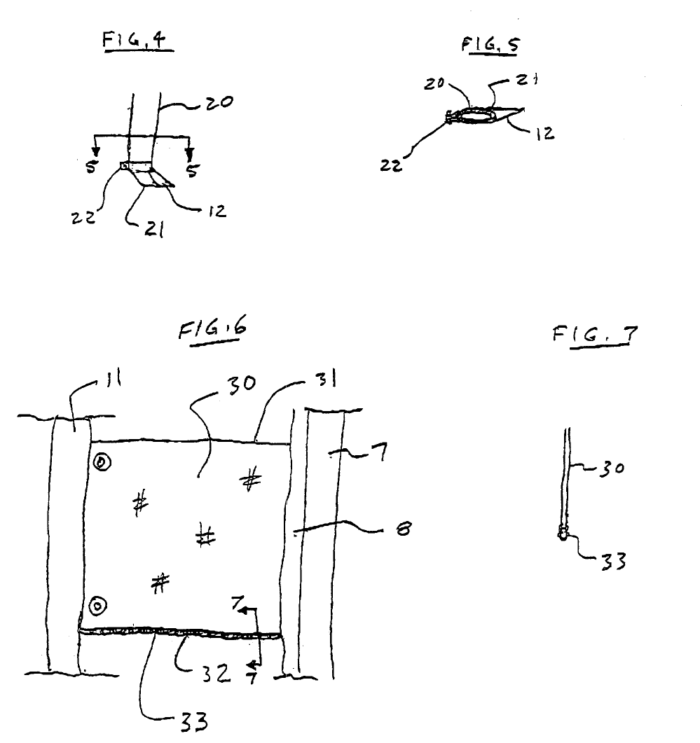

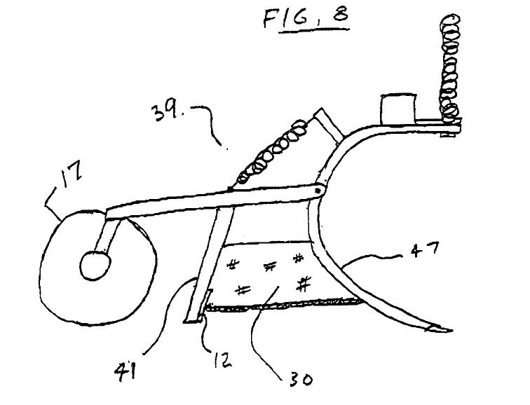

The shank assembly 9 further comprises a flexible membrane 30 attached between the front and rear shanks 7, 11. The membrane 30 has a bottom edge 32 in proximity to the ground 5 when in an operating position as illustrated in FIG. 1. The membrane 30 extends upward from the bottom edge 32 to the top edge 31 located at a suitable upper mid-point of each shank 7, 11. The bottom edge 32 of the membrane 30 is reinforced with a flexible wear element, such as the chain 33 illustrated in FIGS. 6 and 7, to extend the life of the membrane 30, since this bottom edge 32 will wear as it contacts the ground 5. The chain 30 can be attached to the bottom edge of the membrane 30 with flexible ties or the like. A high wearing nylon or plastic cable, or a steel cable could be incorporated as the wear element as well.

In the embodiment of FIG. 1 the rear shank 11 is connected to the front shank 7 by a tether chain 18, such that the shanks can move toward each other, but can move away from each other only as far as the tether chain 18 allows, which is the normal operating position. The membrane 30 is a flexible sheet that is fairly tight when the front and rear shanks 7, 11 are in this normal operating position.

The membrane 30 could be elastic as well as flexible, allowing for further independent movement of the shanks 7, 11 away from each other as is required in some seeders instead of only allowing movement toward each other.

An alternate shank assembly 39 is illustrated in FIG. 8 where an elastic membrane might be used, since the rear shank 41 moves back and forth independently of the front shank 47. Alternatively the membrane 30 could be mounted loosely between the two shanks 41, 47 to allow the membrane to extend to the farthest possible distance between the shanks that the configuration allows.

The ground engaging front face 12 of the rear shank 41 is oriented at an angle in FIG. 8, however the membrane 30 could be used with the embodiment of FIG. 1 or 8 with a conventional furrow opener as well.

Where the membrane 30 is elastic, the chain links of a reinforcing element at the bottom edge 32 of the membrane 30 could be elongate, allowing the membrane 30 to stretch.

The membrane 30 prevents trash and residue from wrapping around the front shanks 7, 47. Essentially the trash flows around the front shank 7, 47 and slides down each side of the membrane 30 and passes on each side of the rear shank 11, 41. The membrane 30 is constantly flexing due to trash and soil moving against it from each side. This flexing of the membrane 30 sheds wet soil and trash such that same do not build up on the membrane 30.

A packer 17 is attached to the shank assemblies 9, 39 and adapted to pack soil over one or both furrows 1, 2.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

I claim:

1. A seeder for depositing first and second agricultural products in laterally separated furrows in the ground when traveling along the ground in an operating travel direction, the seeder comprising:
a front furrow opener mounted on the seeder so as to engage the ground and form a first furrow therein,
a first tube for delivering the first agricultural product to the first furrow;
a rear furrow opener mounted on the seeder separately and behind the front furrow opener so as to engage the ground and form a second furrow therein beside the first furrow, the rear furrow opener having a ground engaging front face oriented at an angle to the operating travel direction such that a far side of the face, farthest from the first furrow, is ahead of an opposite near side of the face such that soil engaged by the face is pushed toward the first furrow; and
a second tube for delivering the second agricultural product to the second furrow.

2. The seeder of claim 1 wherein the ground engaging front face of the rear furrow opener is substantially flat and oriented at an angle of less than 70 degrees relative to the operating travel direction.

3. The seeder of claim 2 wherein the ground engaging front face of the rear furrow opener is oriented at an angle of between 30 and 70 degrees relative to the operating travel direction.

4. The seeder of claim 1 wherein the first furrow is deeper than the second furrow.

5. The seeder of claim 1 wherein the front and rear furrow openers are mounted at a bottom end of respective front and rear shanks.

6. The seeder of claim 1 wherein the front furrow opener is mounted at a bottom end of a first shank, and the rear furrow opener is mounted on an arm extending rear ward from the first shank.

7. The seeder of claim 1 wherein the front furrow opener is a blade-type furrow opener.

8. The seeder of claim 1 wherein the front furrow opener includes a furrow opening disk.

9. The seeder of claim 5 further comprising a flexible membrane attached between the front and rear shanks, the membrane having a bottom edge in proximity to the ground when in an operating position, and wherein the membrane extends upward from the bottom edge.

10. The seeder of claim 9 wherein the bottom edge of the membrane is reinforced with a flexible wear element.

11. The seeder of claim 9 wherein the membrane is elastic.

12. The seeder of claim 1 further comprising a packer adapted to pack soil over at least the second agricultural product in the second furrow.

13. A shank assembly adapted for mounting on a seeder frame to deposit fertilizer and seed in laterally separated bands in the ground, the shank assembly comprising:
a front shank having a bottom end adapted to engage the ground and form a first furrow therein;
a fertilizer tube for delivering fertilizer to the first furrow;
a rear shank located behind the front shank having a bottom end adapted to engage the ground and form a second furrow therein beside the first furrow;
a seed tube for delivering seed to the second furrow;
wherein the bottom end of the rear shank has a substantially flat ground engaging front face oriented at an angle to the operating travel direction such that a far side of the face, farthest from the first furrow, is ahead of an opposite near side of the face such that soil engaged by the face is pushed toward the first furrow.

14. The seeder of claim 13 wherein the ground engaging front face at the bottom end of the rear shank is oriented at an angle of less than 70 degrees relative to the operating travel direction.

15. The seeder of claim 14 wherein the ground engaging front face at the bottom end of the rear shank is oriented at an angle of between 30 and 70 degrees relative to the operating travel direction.

16. The seeder of claim 13 wherein the bottom end of the front shank is adapted to form the first furrow by attachment thereto of a front furrow opening member.

17. The seeder of claim 16 wherein the front furrow opening member comprises a blade-type furrow opener.

18. The seeder of claim 16 wherein the front furrow opening member comprises a furrow opening disk.

19. The seeder of claim 13 wherein the first furrow is deeper than the second furrow.

20. A seeder for depositing first and second agricultural products in laterally separated furrows in the ground when traveling along the ground in an operating travel direction, the seeder comprising:
a front shank mounted on the seeder and having a bottom end adapted to engage the ground and form a first furrow therein;
a first tube for delivering the first agricultural product to the first furrow;
rear shank mounted on the seeder behind the front shank and having a bottom end adapted to engage the ground and form a second furrow therein beside the first furrow;
a second tube for delivering the second agricultural product to the second furrow; and
a flexible membrane attached between the front and rear shanks, the membrane having a bottom edge in proximity to the ground when in an operating position, and the membrane extending upward from the bottom edge.

21. The seeder of claim 20 wherein the membrane is elastic.

22. The seeder of claim 20 wherein the bottom edge of the membrane is reinforced with a flexible wear element.

23. The seeder of claim 20 wherein the bottom end of the rear shank has a ground engaging front face oriented at an angle to the operating travel direction such that a far side of the face, farthest from the first furrow, is ahead of an opposite near side of the face such that soil engaged by the face is pushed toward the first furrow.

24. The seeder of claim 23 wherein the ground engaging front face at the bottom end of the rear shank is oriented at an angle of less than 70 degrees relative to the operating travel direction.

25. The seeder of claim 24 wherein the ground engaging front face at the bottom end of the rear shank is oriented at an angle of between 30 and 70 degrees relative to the operating travel direction.

26. The seeder of claim 20 wherein the first furrow is deeper than the second furrow.
